(19) United States
(12) Patent Application Publication
(10) Pub. No.: US 2026/0145194 A1
(43) Pub. Date: May 28, 2026

(54) KIT FOR MODIFYING OPERATIONAL MODE OF IMPACT SPRINKLER

(71) Applicant: Senninger Irrigation, Inc., Clermont, FL (US)

(72) Inventors: Gregory S. Burcham, Falkville, AL (US); Kyle R. Kieser, Clermont, FL (US)

(21) Appl. No.: 18/959,038

(22) Filed: Nov. 25, 2024

(51) Int. Cl. B05B 12/02; B05B 3/10

(52) U.S. Cl. CPC B05B 12/02; B05B 3/1007

(57) ABSTRACT

A kit is disclosed for modifying a step by step rotatable sprinkler head from full-circle operation in only a forward direction to part-circle operation in both the forward direction and a reverse direction. The sprinkler head being attached to a water supply riser via a fitting. The kit includes a trip assembly module configured for engagement to the sprinkler head, an assembly module clip configured to lock the trip assembly module to the sprinkler head, a trip stop adapter configured to secure to the fitting, and one or more trip stops configured to secure to the trip stop adapter.

### BACKGROUND

### Technical Field

This invention relates to sprinklers and more particularly to sprinkler heads of a step by step rotary type used for irrigation and rotated by an impulse arm intermittently engaging a stream of water and kits for converting such sprinklers from full-circle to part-circle rotation.

### Description of the Related Art

Impulse type step by step rotary sprinkler heads have come into extensive use in agricultural irrigation. In agriculture irrigation, the sprinkler heads are normally carried on pipes rising to an elevation above the agriculture. Many rotary sprinkler heads are configured to provide a full-circle water pattern. In some instances, it is desirable to limit the water pattern to less than a full-circle water pattern to create a part-circle water pattern.

### SUMMARY

In many installations and circumstances, it is desirable to employ irrigation sprinklers of the so-called impact drive type. Impact drive type sprinklers that provide a full-circle water pattern are well known and employ few components making them cost-efficient and reliable. However, in some circumstances, it is desirable to limit the water pattern to less than a full-circle water pattern by employing an impact drive type sprinkler that can create a part-circle water pattern. A disadvantage of such part-circle impact type sprinklers is they employ a complex reversing mechanism.

Such reversing mechanisms are often constructed from a relatively large number of component parts. In this way, careful assembly is required to ensure proper sprinkler operation. For example, reversing mechanisms can require careful assembly of several component parts which, in operation, are subject to wear. Further, reversing mechanism can exhibit a tendency to bind or otherwise fail in operation when dirt, grit, or other foreign material accumulates within the sprinkler. The reversing mechanism increases the cost and complexity for the part-circle impact type sprinklers as compared to full-circle impact type drive sprinklers. Thus, users have a preference for employing full-circle impact drive type sprinklers where the functionality or mode of part-circle operation is not required.

While a user could deploy only part-circle drive sprinklers and then set them individually to provide a full-circle water pattern or a part-circle water pattern, the user would have to incur the unnecessary additional cost and complexity of part-circle impact drive type sprinklers. Alternatively, the user could swap out the entire full-circle impact drive sprinkler for a new part-circle impact drive sprinkler. However, the user may not have immediate use for the removed full-circle drive sprinkler and instead have to store the removed sprinkler until needed if ever. Instead, it would be desirable to have a part-circle kit that includes a minimum number of parts which when (1) not installed allows the full-circle impact drive sprinkler to operate simply and reliably and (2) when installed effectively turns the full-circle impact drive sprinkler into a part-circle impact drive sprinkler.

The user is able to employ the simpler and more cost-effective full-circle impact drive sprinklers while also being able to selectively modify any of the full-circle impact drive sprinklers to operate as a part-circle impact sprinkler without replacing the sprinkler. The user is further able to remove the part-circle kit from a converted impact type sprinkler to return the converted impact drive sprinkler to its original full-circle mode of operation.

In this way, the user is able to maintain the cost-efficiency and simplicity of employing full-circle impact drive sprinklers in most locations within a zone while also having the flexibility to modify any of the existing full-circle impact drive sprinklers in certain locations within the zone to operate in a part-circle mode. Advantageously, the part-circle kit does not require swapping out the full-circle impact drive sprinkler for a part-circle impact drive sprinkler to change between the two modes of operation.

An aspect is directed to a kit for modifying a step by step rotatable sprinkler head from full-circle operation in only a forward direction to part-circle operation in both the forward direction and a reverse direction. The sprinkler head is attached to a water supply riser via a fitting. The kit comprises a trip assembly module configured for engagement to the sprinkler head, an assembly module clip configured to lock the trip assembly module to the sprinkler head, a trip stop adapter configured to secure to the fitting, and one or more trip stops configured to secure to the trip stop adapter.

A variation of the aspect above is, wherein the sprinkler head comprises a sprinkler body and an impulse arm rotatable relative to the sprinkler body, and wherein the trip assembly module comprises a receiver configured to intermittently contact the impulse arm when operating in the reverse direction.

A variation of the aspect above is, wherein the receiver is further configured to not contact the impulse arm when operating in the forward direction.

A variation of the aspect above is, wherein the trip assembly module further comprises a lever configured to contact the one or more trip stops so as to switch the sprinkler head between operating in the forward direction and the reverse direction.

A variation of the aspect above is, wherein the one or more trip stops comprise wings, and wherein the contact with the one or more trip stops is with the wings.

A variation of the aspect above is, wherein the lever is coupled to the receiver.

A variation of the aspect above is, wherein the trip assembly module comprises a lower trip, an upper trip, and a spring coupled to both the lower trip and the upper trip, and wherein the upper trip comprises the receiver and the lower trip comprises the lever.

A variation of the aspect above is, wherein the trip assembly module comprises a channel sized and shaped to surround a portion of the sprinkler head.

A variation of the aspect above is, wherein the portion is a rear extension of the sprinkler head.

A variation of the aspect above is, wherein the assembly module clip comprises a latch configured to engage with the trip assembly module to lock the trip assembly module to the sprinkler head.

A variation of the aspect above is, wherein the trip stop adapter comprises multiple pieces configured to snap together to form a ring or annular shape around the fitting.

A variation of the aspect above is, wherein the trip stop adapter comprises one or more grooves configured to receive the one or more trip stops.

A variation of the aspect above is, wherein the trip stop adapter comprises one or more flat surfaces to engage with the fitting so as to prevent relative rotation between the trip stop adapter and the fitting.

An aspect is directed to a kit for modifying an operational mode of a step by step rotatable sprinkler head from full-circle operation in only a forward direction to part-circle operation in both the forward direction and a reverse direction. The sprinkler head is attached to a water supply riser via a fitting. The kit comprises a trip assembly module configured for engagement to the sprinkler head. The trip assembly module comprises a lower trip having a lever, and an upper trip having a receiver, wherein the lever is mechanically coupled to the receiver so that when the lever moves between a first position and a second position the receiver switches the operational mode of the sprinkler head between the forward direction and the reverse direction, and one or more trip stops configured to be secured relative to the fitting and intermittently contact the lever to move the lever between the first position and the second position.

A variation of the aspect above, further comprises an assembly module clip configured to lock the trip assembly module to the sprinkler head.

A variation of the aspect above, further comprises a trip stop adapter configured to be secured between the one or more trip stops and the fitting.

An aspect is directed to a step by step rotatable sprinkler head modified from full-circle operation in only a forward direction to part-circle operation in both the forward direction and a reverse direction by attachment of a kit. The sprinkler head comprises a rotatable sprinkler body adapted to be coupled to a source of water under pressure via a fitting, a nozzle attached to the sprinkler body for discharging a stream of water therethrough, an impulse arm mounted to the sprinkler body, the impulse arm having a water engaging portion for repelling the impulse arm from the stream of water upon engagement therewith, a spring connected to the sprinkler body for biasing the impulse arm for movement in a direction for engagement with the water stream being discharged by the nozzle, a trip assembly module coupled to the sprinkler head, an assembly module clip locked to the trip assembly module, a trip stop adapter configured to secure to the fitting, and one or more trip stops configured to secure to the trip stop adapter.

A variation of the aspect above is, wherein the trip assembly module comprises a receiver configured to contact the impulse arm when operating in the reverse direction and not contact the impulse arm when operating in the forward direction.

A variation of the aspect above is, wherein the trip assembly module further comprises a lever configured to contact the one or more trip stops so as to switch between the forward direction and the reverse direction.

A variation of the aspect above is, wherein the one or more trip stops comprise wings, and wherein the contact with the one or more trip stops is with the wings.

### BRIEF DESCRIPTION OF THE DRAWINGS

The present disclosure is described with reference to the accompanying drawings, in which like reference characters reference like elements, and wherein:

FIG. 1 is a side view of a sprinkler head with a part-circle kit installed according to the disclosure.

FIG. 2 is bottom view of the sprinkler head with the part-circle kit from FIG. 1 installed.

FIG. 3 is a cross-section view of the sprinkler head with the part-circle kit of FIG. 2 taken along the cut-plane A-A.

FIG. 4 is a partial exploded view of the sprinkler head and the part-circle kit from FIG. 1 showing the part-circle kit positioned for installation on the sprinkler head.

FIG. 5 is a perspective view of the sprinkler head with a trip assembly module and an assembly module clip of the part-circle kit from FIG. 1 in exploded form.

FIG. 6 is a perspective view of the sprinkler head with trip stops and associated trop stop adapter from FIG. 1 in exploded form.

FIG. 7 is a perspective view of the sprinkler head with the trip assembly module, the assembly module clip, the trip stops, and the associated trip stop adapter from FIG. 1 installed on the sprinkler.

FIG. 8 is a side view of an alternate embodiment of the sprinkler head from FIG. 1 that employs a different trip stop and associated trip stop adapter.

FIG. 9 is another view of the embodiment illustrated in FIG. 8 with the receiver in a lowered position to allow full circle operation of the sprinkler head.

FIG. 10 is a side view of the embodiment illustrated in FIG. 8 with the receiver in a lowered position to allow full circle operation of the sprinkler head.

FIG. 11 is another side view of the embodiment illustrated in FIG. 8 with the receiver in a lowered position to allow full circle operation of the sprinkler head.

FIG. 12 is another side view of the embodiment illustrated in FIG. 8 with the receiver in a lowered position to allow full circle operation of the sprinkler head.

### DETAILED DESCRIPTION

An impact sprinkler that can receive a bolt-on part-circle kit 18 to customized its water pattern is disclosed herein. The addition of the bolt-on part-circle kit 18 modifies the functionality or operating mode of the impact sprinkler. In certain embodiments, the part-circle kit 18 includes a reverse engagement lever and an adjustable trip stop mechanism. Advantageously, certain embodiments of the impact sprinkler and part-circle kit 18 provide an impulse arm type rotary irrigation sprinkler head which is simple in construction, economical to manufacture and effective in operation in overcoming problems experienced with deployment of prior art sprinkler heads.

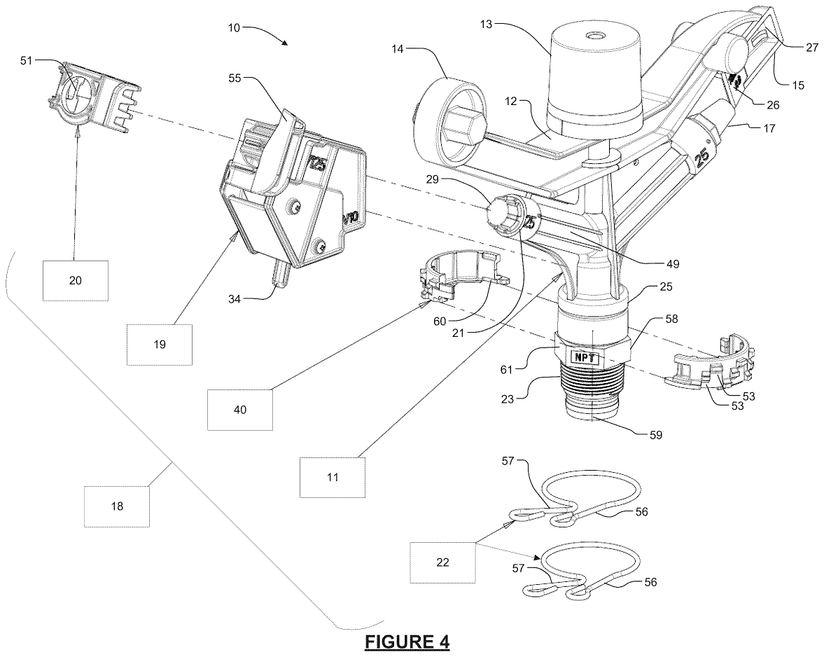

In certain embodiments, the part-circle kit 18 (see FIG. 4) can be provided with the impact sprinkler or body to allow a user to decide whether to install the part-circle kit 18 at any point in time. In certain embodiments, the part-circle kit 18 can be acquired separately from acquiring the impact sprinkler. Thus, if the user desires a part-circle water pattern in the location of an existing full-circle impact sprinkler, the user can simply acquire and install the part-circle kit 18.

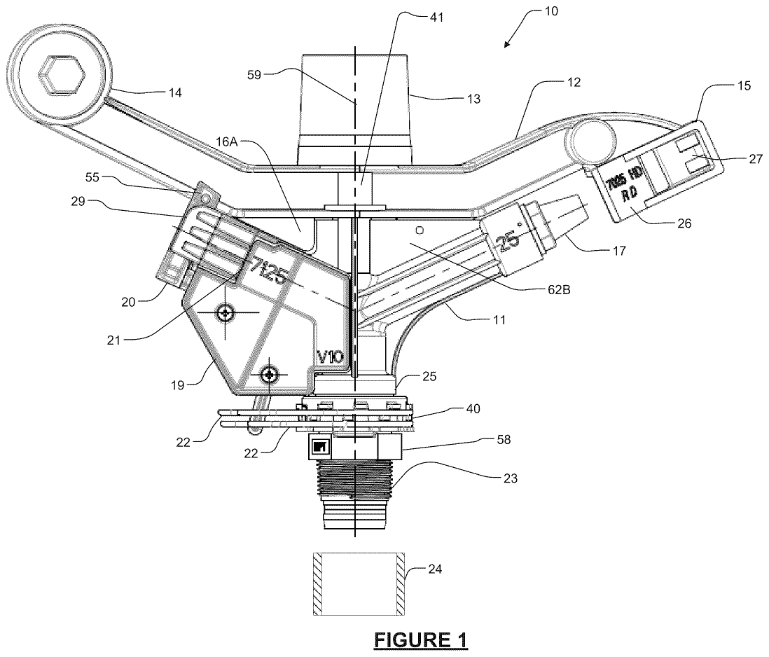

FIG. 1 is a side view of a sprinkler head 10 with the part-circle kit 18 installed according to the disclosure. The sprinkler head 10 is an impulse type and step by step rotary irrigation sprinkler head 10. The sprinkler head 10 comprises a sprinkler head body 11 with an impulse arm 12 which is operated by a spring located in a spring cover 13. The spring cover 13 keeps the bearing and spring clean.

The impulse arm 12 includes a counter weight 14 and a water engaging portion or spoon 15 on opposite ends of the impulse arm 12. The impulse arm 12 may assume a position in which the water engaging portion or spoon 15 lies in the path of a jet issuing from a nozzle 17. Advantageously, the part-circle kit 18 allows the user to customize the desired water pattern for a plurality of impact sprinklers by adding the part-circle kit 18 to certain sprinklers within the plurality of impact sprinklers while maintaining the full-circle water pattern of other sprinklers within the plurality of sprinklers.

Impact drive sprinklers are used for supplying irrigation water to irrigate vegetation, such as grass, shrubs, crops, and the like. The sprinkler body 11 is rotatably carried within a journal bearing or rotatable connection 25 adapted for connection to the upper end of a water supply riser or standpipe 24. Irrigation water flows upwardly through the water supply riser 24 and passes through the sprinkler body 11 for projection outwardly as the jet of water from the nozzle 17. In this way, the sprinkler body 11 provides an irrigation water stream for irrigation purposes.

The sprinkler head 10 is automatically operated by the force of the issuing jet of water to cause the sprinkler body 11 to rotate in one direction (e.g., clockwise direction when looking downward for ease of description) with a step-by-step movement. With the part-circle kit 18 installed, at a predetermined point the sprinkler body 11 automatically reverses its direction of rotation and rotates in the opposite direction with a step-by-step movement. The part-circle kit 18 further enables the angle of swing of the sprinkler body 11 to be readily adjusted to any desired angle.

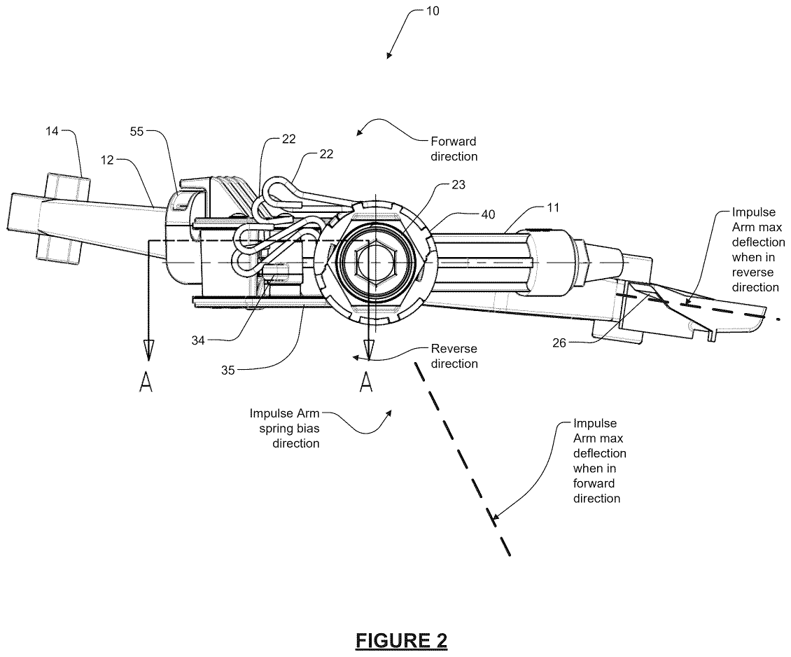

FIG. 2 is bottom view of the sprinkler head 10 with the part-circle kit 18 from FIG. 1 installed. The sprinkler head 10 is mounted for rotation on a more or less upright or vertical axis 59. For example, in certain embodiments, an impulse arm 12 is mounted on the sprinkler body 11 and urged by a metal coil spring or the like to swing the water engaging portion or spoon 15 on the impulse arm 12 laterally into interrupting engagement with the projected water stream and further to impact the sprinkler body 11 so as to rotate the sprinkler body 11 through a small rotational step about the axis 59 of the water supply riser 24. In this way, the projected water stream is slightly shifted.

After such impact, the water stream drives the water engaging portion or spoon 15 laterally out of the stream resulting in a recoiling of the spring for subsequent spring-biased return of the water engaging portion or spoon 15 into interrupting the stream as well as impacting the sprinkler body 11. The sprinkler head 10 is thus rotated about the axis 59 of the water supply riser 24 in a regular sequence of small angular steps to sweep the water stream over a relatively large terrain area. In this way, the sprinkler head 10 provides a nozzle 17 that throws a stream of water a considerable distance and is intermittently interrupted by the water engaging portion or spoon 15 of the impulse arm 12. The impulse arm 12 is utilized for rotating the sprinkler head 10 in its intermittent steps.

The bolt-on part-circle kit 18 converts a full-circle sprinkler to operate as a part-circle sprinkler. In this way, the part-circle impact type sprinkler employs the bolt-on part-circle kit 18 to obtain reversible sprinkler rotation back and forth between selected end limits of an arcuate part-circle path.

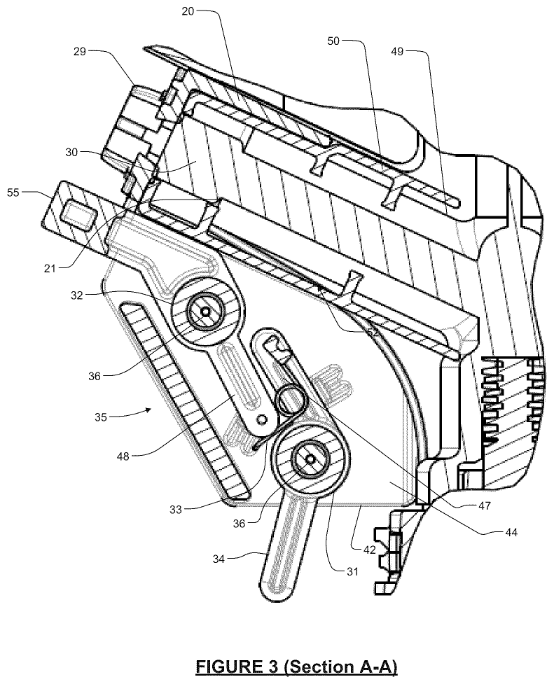

FIG. 3 is a cross-section view of the sprinkler head 10 with the part-circle kit 18 of FIG. 2 taken along the cut-plane A-A. FIG. 4 is a partial exploded view of the sprinkler head 10 and the part-circle kit 18 from FIG. 1 showing the part-circle kit 18 positioned for installation on the sprinkler head 10. In certain embodiments, the part-circle kit 18 can include a trip assembly module 19, an assembly module clip 20, trip stops 22, and a trip stop adapter 40. In certain embodiments, the part-circle kit 18 further comprises the sprinkler body 11.

The trip assembly module 19 comprises the lever 34 which switches the direction of rotational operation for the sprinkler body 11. For example, the part-circle kit 18 can be mounted on the sprinkler body 11 and, via the lever 34, shifts movement between a forward-drive position relative to the path of the swinging impulse arm 12 to permit sprinkler rotation in one direction (e.g., clockwise direction for ease of description) and a reverse-drive position for impact engagement by the impulse arm 12 at a point for stepwise sprinkler rotation in an opposite direction (e.g., counterclockwise direction for ease of description) as shown in FIG. 2.

Referring to FIG. 3, in certain embodiments, the lever 34 is coupled, directly or indirectly, to a receiver 55 via one or more gears, levers, arm, etc. In this way, movement of the lever 34 triggers movement of the receiver 55 into or out of the rotational path of the impulse arm 12. The receiver 55 is normally shifted and retained in the desired forward-drive position (e.g., out of the path of the impulse arm 12) or reverse-drive position (e.g., in the path of the impulse arm 12) when the trip assembly module 19 is tripped by the lever 34. In this way, the lever 34 is movable between the forward-drive position and the reverse-drive position.

Referring to FIG. 4, movement of the lever 34 between the forward-drive position and the reverse-drive position is caused by engagement with wings 56, 57 of the trip stops 22. In the illustrated embodiment, the wing 56 engages with the lever 34 to move the lever 34 to the reverse-drive position (e.g., away from the axis 59) while the wing 57 engages with the lever 34 to move the lever 34 to the forward drive position (e.g., towards the axis 59). In certain embodiments, the lever 34 contacts the wing 56 of a first trip stop 22 to switch to the reverse drive mode and then subsequently contacts the wing 57 of a second trip stop 22 to switch back to the forward drive mode. Of course the wings 56, 57 can have other shapes which by contacting the lever 34 changes the direction of rotation for the sprinkler body 11.

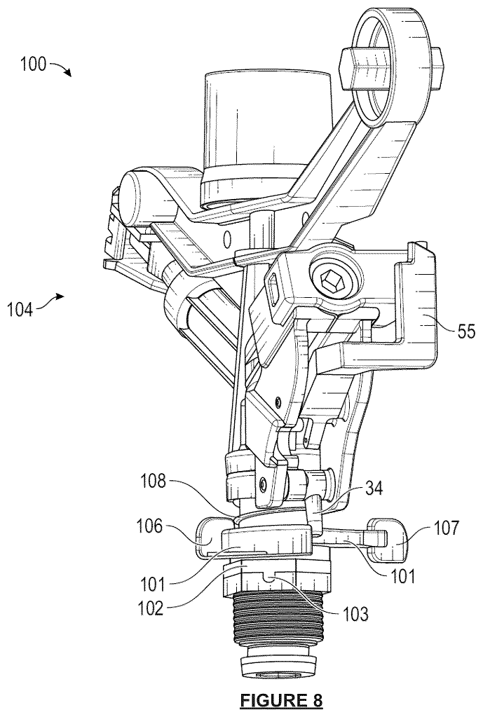

The trip stop adapter 40 can comprise multiple pieces (e.g., two molded pieces) which snap together to form a ring or annular shape around at least a portion of a standard fitting 58 disposed on the water supply riser 24 side of the rotatable connection 25. The trip stop adapter 40 is carried at least in part by the standard fitting 58 below the rotatable connection 25 of the sprinkler head 10. In this way, the trip stop adapter 40 does not rotate with the sprinkler head 10. Advantageously, the multi-piece trip stop adapter 40 can be installed without disconnecting the sprinkler head 10. In certain embodiments (e.g., FIGS. 8-12), the trip stop adapter 102 can be a single piece.

In certain embodiments, an inner surface of the trip stop adapter 40 comprises one or more flat surfaces 60 configured to engage with one or more flat surfaces 61 of the fitting 58 to prevent relative rotation between the trip stop adapter 40 and the fitting 58. As explained below, the trip stops 22 engage with an outer surface of the trip stop adapter 40 to allow the user to readily adjust the angle of swing of the sprinkler body 11 to any desired angle by rotating the trip stops 22 about the outer circumference of the trip stop adapter 40. For example, in certain embodiments when assembled, wings 56, 57 of the trip stops 22 project outwardly from the trip stop adapter 40. The user can set the wings 56, 57 at selected circumferential positions about the trip stop adapter 40 corresponding with the selected end limits of the part-circle path.

The impulse arm 12 can carry a sleeve 41 mounted for rotation on a fixed post aligned with the axis 59 of rotation. The rear portion of the impulse arm 12 is constructed so as to cooperate with the receiver 55. The receiver 55 is coupled to the lever 34. The rear portion of the impulse arm 12 is configured so as to strike the receiver 55 if the receiver 55 is in the reverse position illustrated in FIG. 1. The illustrated position of the receiver 55 corresponds to causing a counterclockwise rotation of the sprinkler body 11. The forward end of the impulse arm 12 is formed with the water engaging portion or spoon 15 which intermittently comes into the path of the jet of water.

The sprinkler body 11 has one or more webs 62A, 62B for stopping the impulse arm 12 from proceeding past a certain point when the sprinkler 10 is operating. In the illustrated embodiment, one or more protruding members 16A, 16B on the impulse arm 12 contact the one or more webs 62A, 62B. When the sprinkler head 10 is operating in the forward direction, the impulse arm 12 swings in the counterclockwise direction and through a relatively large angle so as to build up considerable force in the return spring that returns the impulse arm 12 into the jet. Eventually the force of this spring checks the momentum given to the impulse arm 12 by the jet and returns the impulse arm 12 to impact against the one or more webs 62A, 62B on the sprinkler body 11. This impact transfers the momentum of the returning impulse arm 12 to the sprinkler body 11 and causes the step-by-step rotation in the forward direction, that is to say, in a clockwise direction.

When the part-circle kit 18 is installed, the receiver 55 can be automatically moved into the path of the impulse arm 12 to cause the sprinkler head 10 to operate in the reverse direction. As mentioned above, the force of the water impinging on the water engaging portion or spoon 15 causes a swing of the impulse arm 12 in the counterclockwise direction. However, the receiver 55 arrests this counterclockwise rotation which transfers the momentum of the impulse arm 12 to the sprinkler body 11 to cause the same to rotate in the reverse direction. In this way, the receiver 55 limits the swing angle in the counterclockwise direction so that less of the momentum of the impulse arm 12 imparted by the jet is stored in the return spring. Instead, the impulse arm 12 impinges or impacts on the receiver 55 causing the momentum of the impulse arm 12 to rotate the sprinkler body 11 in the reverse direction on its axis 59. For ease of explanation, this direction of rotation is counterclockwise when looking down on the sprinkler head 11.

After each impingement of the impulse arm 12 against the receiver 55 which causes a slight reverse rotation of the sprinkler body 11, the impulse arm 12 returns in the clockwise direction so that the water engaging portion or spoon 15 is brought back into the path of the water jet. When this occurs, the end of the impulse arm 12 is arrested by contact between the one or more protruding members 16A, 16B and the one or more webs 62A, 62B with the water engaging portion or spoon 15 substantially in line with the jet. However, the momentum of the clockwise movement of the impulse arm 12 is insufficient to move the sprinkler body 11 in the forward direction.

In certain embodiments, after the sprinkler body 11 is rotated through a predetermined angle, the receiver 55 is automatically shifted so that it is out of the path of the impulse arm 12 and the sprinkler body 11 can switch to forward operation.

The sprinkler body 11 is illustrated as being formed in an upward facing V-shape. The rear leg of the V-shape comprises a rear extension 49. A distal end of the rear extension 49 comprises a rear opening 21 configured to receive a rear nozzle or plug 29. The rear opening 21 is in flow communication with the water supply riser 24. The rear nozzle or plug 29 may be unscrewed and may alternatively have a nozzle inserted or a plug to block the exit of water through the rear extension 49 of the sprinkler head 10. In certain embodiments, the rear spreader nozzle 29 provides better coverage of the area being irrigated. The rear nozzle 29 on such a sprinkler head 10 can provide a more uniform watering pattern.

Referring to FIG. 1, the sprinkler head 10 is illustrated as having threads 23 threaded into the water supply riser 24. The sprinkler head 10 has a rotatable connection 25 so that the sprinkler head may be easily inserted by threading into the water supply riser 24 and is adapted to rotate on the rotatable connection 25, which may have a bearing for ease of rotation.

In certain embodiments, the water engaging portion or spoon 15 has an inclined surface 26 adapted to engage water leaving the nozzle 17 in a manner that water impinging upon the inclined surface 26 will assist the spring in causing the impulse arm 12 to cross the jet issuing from the nozzle 17. In this way, the movement of the impulse arm 12 across the jet of water is assisted by providing the inclined surface 26.

The water engaging portion or spoon 15 also comprises a curved surface 27 downstream of the inclined surface 26. In the illustrated embodiment, at least a portion of the curved surface 27 is generally perpendicular to the inclined surface 26. In this way, the curve surface 27 forms a spoon shape. The jet or stream of water leaving or being discharged from the nozzle 17 engages both the inclined surface 26 and a portion of the curved surface 27. The force caused by the stream engaging the curved surface 27 causes the impulse arm 12 to rotate until the spring in the spring cover 13 will force or bias the impulse arm 12 back towards the water stream if set for forward operation. In contrast, if set for reverse operation, rotation of the impulse arm 12 is limited by the receiver 55. The receiver 55 limits rotation of the impulse arm 12 so as to reduce any force stored by the spring in the spring cover 13 to a low enough level that when the impulse arm 12 returns and contacts the one or more webs 62A, 62B, the sprinkler body 11 does not significantly move in the forward direction. This limited rotation results in the impulse arm 12 immediately contacting or impacting the receiver 55 causing the sprinkler body 11 to rotate stepwise in the reverse direction.

In other words when operating in the forward direction, the momentum imparted on the impulse arm 12 by the stream contacting the curved portioned 27 is gradually diminished as the impulse arm 12 rotates against the spring in the spring cover 13. Since the receiver 55 does not project into the rotational path of the impulse arm 12 when the part-circle kit 18 is set in the forward direction, free rotation of the impulse arm 12 is only impeded by the spring in the spring cover 13. In contrast, when the receiver 55 projects into the rotational path of the impulse arm 12 because the part-circle kit 18 is set in the reverse direction, full rotation of the impulse arm 12 is prevented by the receiver 55. When operating in the reverse direction, the momentum imparted on the impulse arm 12 by the stream contacting the curved portioned 27 is immediately transferred to the sprinkler body 11 when the impulse arm 12 impacts or slams against the receiver 55.

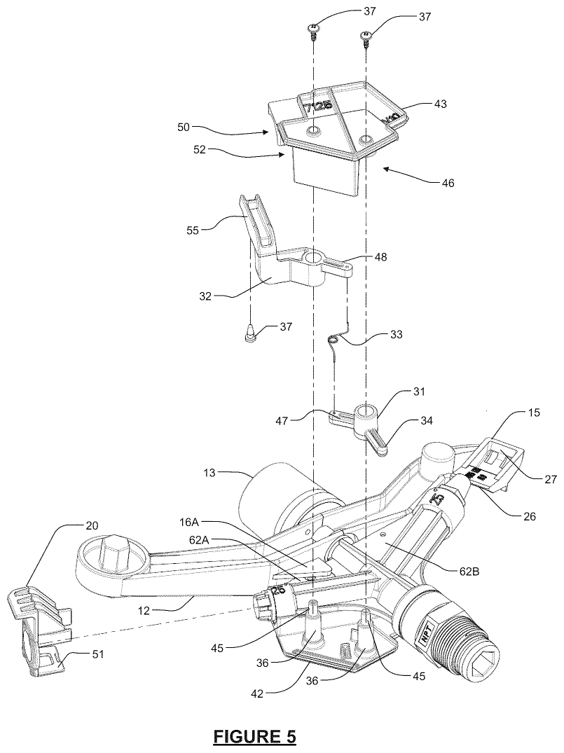

FIG. 5 is a perspective view of the sprinkler head 10 with the trip assembly module 19 and the assembly module clip 20 of the part-circle kit 18 from FIG. 1 in exploded form. The trip assembly module 19 comprises a housing 35 configured to be attached to the sprinkler head 10 by the user to provide part-circle operation. The user can attach the housing 35 to the sprinkler head 10 via the rear extension 49. For example, in certain embodiments, the housing 35 comprises a channel 50 sized and shaped to slide over at least a portion of the rear extension 49. Once slid over the rear extension 49, the user engages the assembly module clip 20 to the trip assembly module 19. In certain embodiments, the assembly module clip 20 is slid onto the end of the channel 50. Once engaged, movement of the trip assembly module 19 in at least one direction relative to the rear extension 49 is prevented.

In certain embodiments, the assembly module clip 20 comprises a latch 51 for engaging with the housing 35 of the trip assembly module 19 to prevent inadvertent separation of the assembly module clip 20 from the trip assembly module 19. For example, in certain embodiments, the assembly module clip 20 is slid onto the end of the channel 50 until the latch 51 engages with the housing 35. In certain embodiments to remove the trip assembly module 19, the user is able to slightly bend or deflect the latch 51 portion of the assembly module clip 20 away from the housing 35 and then slid the assembly module clip 20 off of the end of the rear extension 49. Once removed, the user can slide the trip assembly module 19 off of the rear extension 49 of the sprinkler head 10 if desired to return the sprinkler head 10 to full circle operation.

The trip assembly module 19 further comprises a lower trip 31, an upper trip 32, and a spring 33 disposed at least partially in an interior 44 of the housing 35. The lower trip 31 comprises the lever 34. As explained above, the lever 34 is configured to engage with the trip stops 22 to change the operational mode of the sprinkler head 10 between forward and reverse operation.

The trip assembly module 19 further comprises a plurality of shafts formed as bosses 36 projecting from a wall 42 of the housing 35. The bosses 36 define rotational axes for the lower trip 31 and the upper trip 32. A closure plate 43 covers the interior 44 of the trip assembly module 19 by receiving distal ends 45 of the bosses 36. One or more fasteners 37 secure the closure plate 43 to the bosses 36.

In the illustrated embodiment, the lever 34 is fulcrumed on the boss 36 and extends downward through an opening 46 in the housing 35. An arm 47 of the lower trip 31 is formed integrally with the lever 34 and extends in a generally upward direction. The upper trip 32 comprises an arm 48 and the receiver 55 fulcrumed on the boss 36. A portion of the receiver 55 extends in an upward direction and through an opening 52 in the housing 35. As explained above, a portion of the receiver 55 is configured to extend into the rotational path of the impulse arm 12 when the lever 34 is in the reverse position or configuration and retract from the rotational path of the impulse arm 12 when the lever 34 is in the forward position or configuration.

The arms 47, 48 are configured to engage with opposite ends of the spring 33 so as to transfer rotational motion of the lower trip 31 to the upper trip 32. For example, in certain embodiments, rotational motion of the lower trip 31 about its respective boss 36 in a first direction causes the upper trip 32 to rotate about its respective boss 36 in the first direction. In this way, the lower trip 31 and the upper trip 32 provide for a toggle action when the lever 34 rotates away from or towards the water supply riser 24 about its respective boss 36. As a consequence of this action, the receiver 55 is raised and lowered, accordingly, through the opening 52 and into the path of the impulse arm 12.

The receiver 55, therefore, has a retracted position with its upper end below or at least flush with a bottom face of the impulse arm 12, and a projected position, as in FIG. 1. In certain embodiments, a slot is formed in the bottom face of the impulse arm 12 where the same bears on the receiver 55. A portion of the receiver 55 when projected enters the slot.

When the receiver 55 is retracted, the impulse arm 12 is free to respond to reaction impulses as described above so that the sprinkler body 11 is intermittently rotated in one direction and the path of the jet or stream changes accordingly. When the receiver 55 is projected, the reaction movement of the impulse arm 12 is limited by the receiver 55 causing an intermittent movement of the sprinkler body 11 in the opposite direction. In other words, each time the impulse arm 12 strikes the receiver 55, as in FIG. 2, the sprinkler body 11 is moved and the direction of movement is opposite to movement caused by the percussive or impact force between the impulse arm 12 and the one or more webs 62A, 62B on the sprinkler body 11.

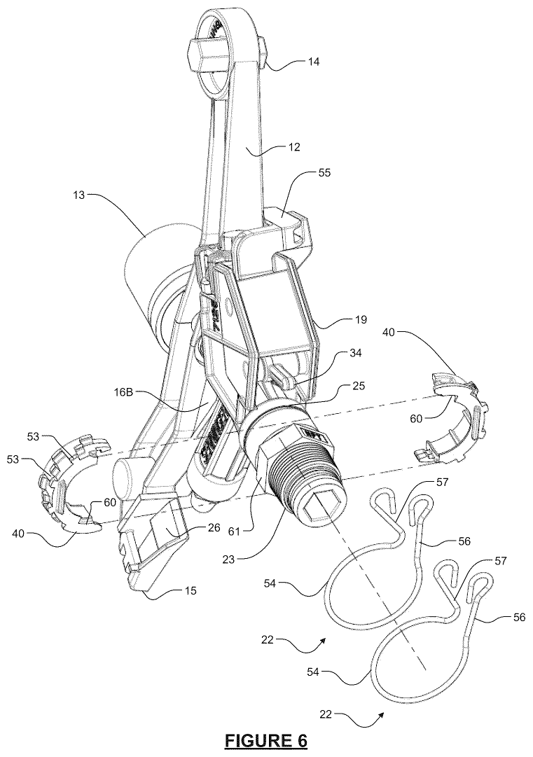

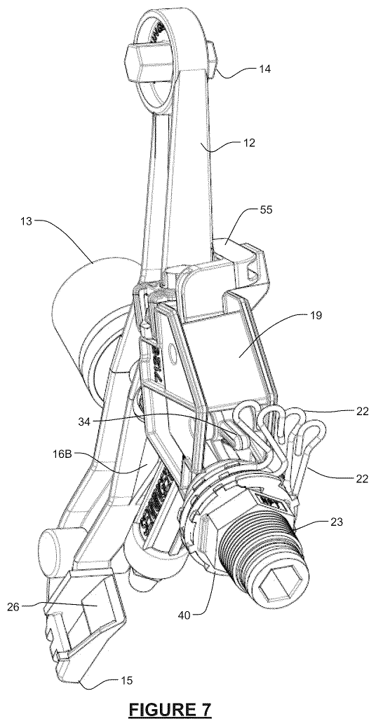

FIG. 6 is a perspective view of the sprinkler head 10 with trip stops 22 and the associated trip stop adapter 40 from FIG. 1 in exploded form. FIG. 7 is a perspective view of the sprinkler head 10 with the trip assembly module 19, the assembly module clip 20, the trip stops 22, and the associated trip stop adapter 40 from FIG. 1 installed on the sprinkler head 10. FIGS. 6 and 7 illustrate two trip stops 22. The two trip stops 22 determine when the lever 34 will be shifted one way or the other to change the direction of rotation. The trip stops 22 are rotationally adjustable around the trip stop adapter 20 to provide a range of adjustment up to 360, if such a large or wide range is desired. To this end, grooves 53 in the trip stop adapter 40 rotationally hold circular portions 54 of the trip stops 22. The included angle of adjustment of the trip stops 22 is varied by rotational adjustment afforded by the mentioned grooves 53 and circular portions 54 and the frictional engagement thereof holds the adjustment until a change in the range of operation of the stream is desired.

In the illustrated embodiment, the wing 56 engages with the lever 34 to move the lever 34 to the reverse-drive position while the wing 57 engages with the lever 34 to move the lever 34 to the forward drive position. In certain embodiments, the lever 34 contacts the wing 56 of a first trip stop 22 to switch to the reverse drive mode and then subsequently contacts the wing 57 of a second trip stop 22 to switch back to the forward drive mode. By directing the trip stops 22 and their associated wings 56, 57 along the desired watering limits, the stream or jet will reach these limits alternately and then move in a reverse direction to the opposite limit.

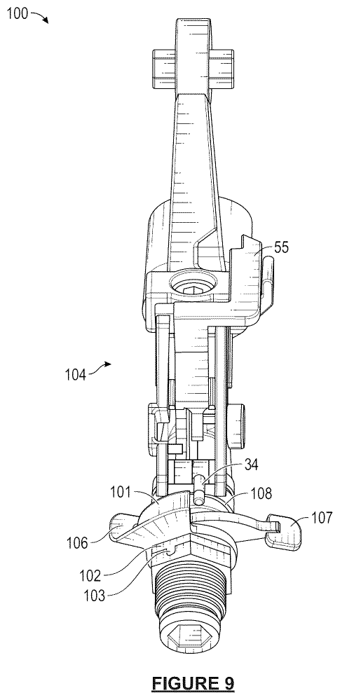

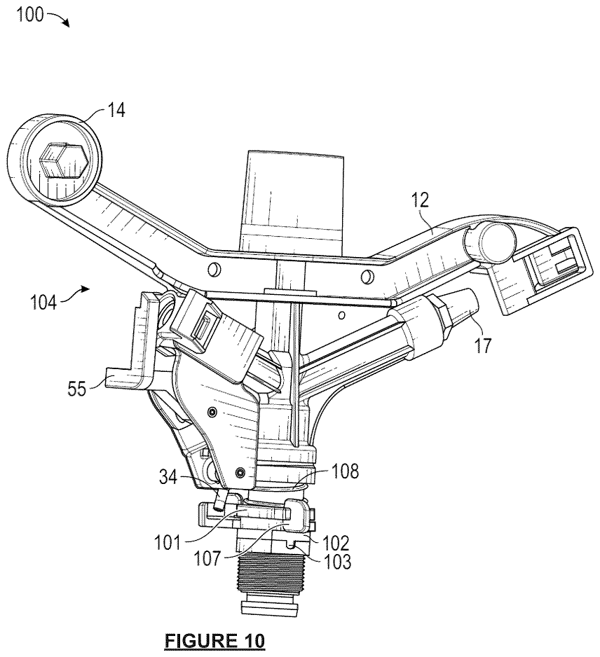

FIG. 8 is a side view of an alternate embodiment of a sprinkler head 100 from FIG. 1 that employs different trip stops 101 and associated trip stop adapter 102 as part of a part-circle kit 104. FIG. 9 is another view of the embodiment illustrated in FIG. 8 with the receiver 55 in a lowered position to allow full circle operation of the sprinkler head 100. FIG. 10 is a side view of the embodiment illustrated in FIG. 8 with the receiver 55 in a lowered position to allow full circle operation of the sprinkler head 10. The part-circle kit 104, unlike the part-circle kit 18, includes a trip stop adapter 102 in the form of a fitting for attaching to the water supply riser 25. In certain embodiments, the trip stop adapter 102 has a hex top with a threaded base for attaching to the water supply riser 25. The trip stops 101 attach to the trip stop adapter 102 with keyed notches 103 to prevent rotation of the trip stops 101 relative to the trip stop adapter 102 and the water supply riser 25.

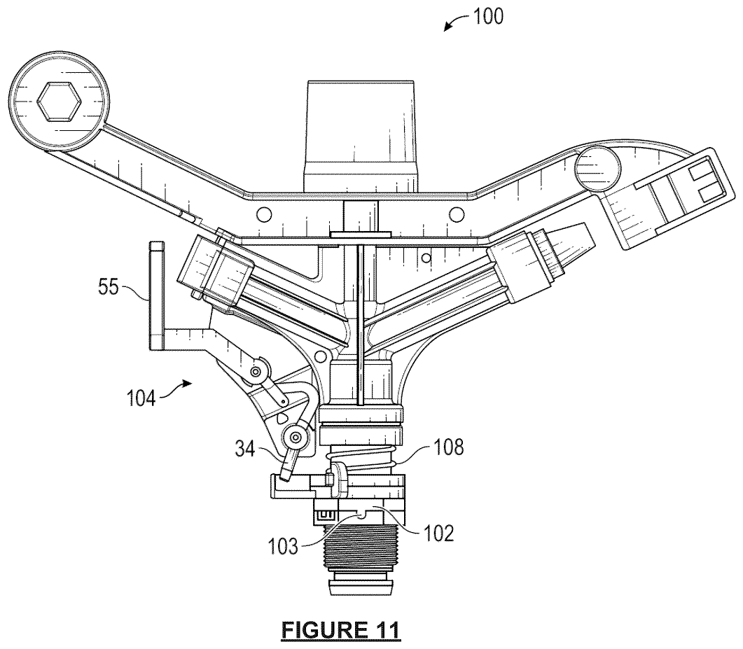

FIG. 11 is another side view of the embodiment illustrated in FIG. 8 with the receiver 55 in a lowered position to allow full circle operation of the sprinkler head 100. In certain embodiments, the trip stops 101 sit on top of the trip stop adapter 102 with each including a wing 106, 107. The wings 106, 107 extend in a radially direction from their respective trip stop 101. In certain embodiments, the trip stops 101 and the trip stop adapter 102 comprise toothed engagement so as to lock the trip stops 101 and the trip stop adapter 102 in place. In certain embodiments, a spring 108 is provided to press the trip stops 101 and the trip stop adapter 102 together.

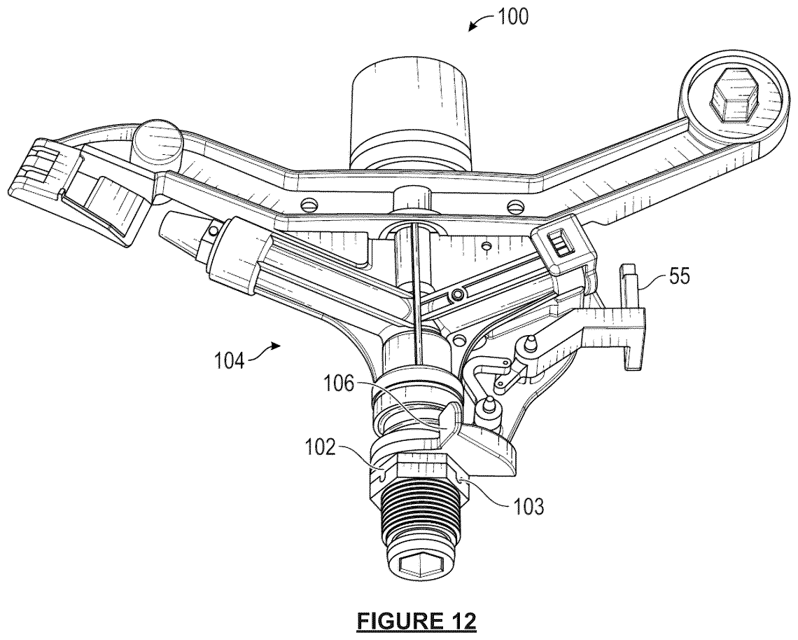

FIG. 12 is another side view of the embodiment illustrated in FIG. 8 with the receiver 55 in a lowered position to allow full circle operation of the sprinkler head 100. The relative position of the wings 106, 107 may be adjusted by lifting one of the trip stops 101 up slightly to disengage the toothed engagement and also slightly compresses the spring 108. Once disengaged, the user is able to rotationally adjust the trip stops 101 around the trip stop adapter 102 to provide a range of adjustment up to 360, if such a large or wide range is desired. Thus, the included angle of adjustment of the trip stops 101 is varied by rotational adjustment afforded by the toothed engagement and spring 108 which holds the adjustment until a change in the range of operation of the stream is desired. In the illustrated embodiment, the wing 106 engages with the lever 34 to move the lever 34 to the reverse-drive position while the wing 107 engages with the lever 34 to move the lever 34 to the forward drive position. By directing the trip stops 101 and their associated wings 106, 107 along the desired watering limits, the stream or jet will reach these limits alternately and then move in a reverse direction to the opposite limit.

For expository purposes, the term “horizontal” as used herein is defined as a plane parallel to the plane or surface of the floor of the area in which the system being described is used or the method being described is performed, regardless of its orientation. The term “floor” floor can be interchanged with the term “ground.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

The terms “approximately”, “about”, “generally” and “substantially” as used herein represent an amount close to the stated amount that still performs a desired function or achieves a desired result. For example, the terms “approximately”, “about”, “generally,” and “substantially” may refer to an amount that is within less than 10% of the stated amount.

What is claimed is:

1. A kit for modifying a step by step rotatable sprinkler head from full-circle operation in only a forward direction to part-circle operation in both the forward direction and a reverse direction, the sprinkler head being attached to a water supply riser via a fitting, the kit comprising:
a trip assembly module configured for engagement to the sprinkler head;
an assembly module clip configured to lock the trip assembly module to the sprinkler head;
a trip stop adapter configured to secure to the fitting; and
one or more trip stops configured to secure to the trip stop adapter.

2. The kit of claim 1, wherein the sprinkler head comprises a sprinkler body and an impulse arm rotatable relative to the sprinkler body, and wherein the trip assembly module comprises a receiver configured to intermittently contact the impulse arm when operating in the reverse direction.

3. The kit of claim 2, wherein the receiver is further configured to not contact the impulse arm when operating in the forward direction.

4. The kit of claim 2, wherein the trip assembly module further comprises a lever configured to contact the one or more trip stops so as to switch the sprinkler head between operating in the forward direction and the reverse direction.

5. The kit of claim 4, wherein the one or more trip stops comprise wings, and wherein the contact with the one or more trip stops is with the wings.

6. The kit of claim 4, wherein the lever is coupled to the receiver.

7. The kit of claim 4, wherein the trip assembly module comprises a lower trip, an upper trip, and a spring coupled to both the lower trip and the upper trip, and wherein the upper trip comprises the receiver and the lower trip comprises the lever.

8. The kit of claim 1, wherein the trip assembly module comprises a channel sized and shaped to surround a portion of the sprinkler head.

9. The kit of claim 8, wherein the portion is a rear extension of the sprinkler head.

10. The kit of claim 1, wherein the assembly module clip comprises a latch configured to engage with the trip assembly module to lock the trip assembly module to the sprinkler head.

11. The kit of claim 1, wherein the trip stop adapter comprises multiple pieces configured to snap together to form a ring or annular shape around the fitting.

12. The kit of claim 1, wherein the trip stop adapter comprises one or more grooves configured to receive the one or more trip stops.

13. The kit of claim 1, wherein the trip stop adapter comprises one or more flat surfaces to engage with the fitting so as to prevent relative rotation between the trip stop adapter and the fitting.

14. A kit for modifying an operational mode of a step by step rotatable sprinkler head from full-circle operation in only a forward direction to part-circle operation in both the forward direction and a reverse direction, the sprinkler head being attached to a water supply riser via a fitting, the kit comprising:
a trip assembly module configured for engagement to the sprinkler head, the trip assembly module comprising,
a lower trip having a lever, and
an upper trip having a receiver,
wherein the lever is mechanically coupled to the receiver so that when the lever moves between a first position and a second position the receiver switches the operational mode of the sprinkler head between the forward direction and the reverse direction; and
one or more trip stops configured to be secured relative to the fitting and intermittently contact the lever to move the lever between the first position and the second position.

15. The kit of claim 14, further comprising an assembly module clip configured to lock the trip assembly module to the sprinkler head.

16. The kit of claim 14, further comprising a trip stop adapter configured to be secured between the one or more trip stops and the fitting.

17. A step by step rotatable sprinkler head modified from full-circle operation in only a forward direction to part-circle operation in both the forward direction and a reverse direction by attachment of a kit, the sprinkler head comprising:
a rotatable sprinkler body adapted to be coupled to a source of water under pressure via a fitting;
a nozzle attached to the sprinkler body for discharging a stream of water therethrough;
an impulse arm mounted to the sprinkler body, the impulse arm having a water engaging portion for repelling the impulse arm from the stream of water upon engagement therewith;
a spring connected to the sprinkler body for biasing the impulse arm for movement in a direction for engagement with the water stream being discharged by the nozzle;
a trip assembly module coupled to the sprinkler head;
an assembly module clip locked to the trip assembly module;
a trip stop adapter configured to secure to the fitting; and
one or more trip stops configured to secure to the trip stop adapter.

18. The step by step rotatable sprinkler head of claim 17, wherein the trip assembly module comprises a receiver configured to contact the impulse arm when operating in the reverse direction and not contact the impulse arm when operating in the forward direction.

19. The step by step rotatable sprinkler head of claim 18, wherein the trip assembly module further comprises a lever configured to contact the one or more trip stops so as to switch between the forward direction and the reverse direction.

20. The step by step rotatable sprinkler head of claim 19, wherein the one or more trip stops comprise wings, and wherein the contact with the one or more trip stops is with the wings.
